(19) United States
(12) Patent Application Publication
(10) Pub. No.: US 2026/0219595 A1
(43) Pub. Date: Jul. 30, 2026

(54) TONER, DEVELOPING AGENT, TONER ACCOMMODATING UNIT, IMAGE FORMING APPARATUS, AND IMAGE FORMING METHOD

(71) Applicants: Hisashi Nakajima, Shizuoka (JP); Yoshitaka Yamauchi, Shizuoka (JP); Masayuki Ishii, Shizuoka (JP); Ayaka Mori, Shizuoka (JP); Shimpei Miyata, Tokyo (JP)

(72) Inventors: Hisashi Nakajima, Shizuoka (JP); Yoshitaka Yamauchi, Shizuoka (JP); Masayuki Ishii, Shizuoka (JP); Ayaka Mori, Shizuoka (JP); Shimpei Miyata, Tokyo (JP)

(73) Assignee: Etria Co., Ltd., Kanagawa (JP)

(21) Appl. No.: 19/456,473

(22) Filed: Jan. 22, 2026

(30) Foreign Application Priority Data
Jan. 29, 2025 (JP) 2025-012603

(51) Int. Cl. G03G 9/087

(52) U.S. Cl. CPC G03G 9/08755; G03G 9/08782

(57) ABSTRACT

A toner contains a toner particle that contains a base toner particle containing a polyester resin, a release agent, and an aromatic petroleum resin, and an external additive including silica particles whose surfaces are at least partially coated with a hydroxide of a metal element, wherein, in a cross section of the toner particle observed with a scanning electron microscope, the aromatic petroleum resin is present at an interface of a domain of the release agent, and domains of the aromatic petroleum resin are dispersed within a matrix of the polyester resin.

### CROSS-REFERENCE TO RELATED APPLICATIONS

This patent application is based on and claims priority pursuant to 35 U.S.C. § 119 to Japanese Patent Application No. 2025-012603 filed on Jan. 29, 2025, in the Japan Patent Office, the entire disclosure of which is hereby incorporated by reference herein.

### BACKGROUND

### Technical Field

The present disclosure relates to a toner, a developing agent, a toner accommodating unit, an image forming apparatus, and an image forming method.

### Description of the Related Art

Traditionally, electrophotographic apparatuses and electrostatic recording apparatuses visualize latent electrical or magnetic images using toner for developing electrostatic latent images (referred to as toner in the present disclosure). For example, in the electrophotography, electrostatic latent images are formed on an electrostatic latent image bearer and developed with toner to form toner images. The toner image is transferred to a recording medium, typically paper, and thereafter fixed thereon by methods such as heating.

In recent years, there has been a demand for toner fixable at lower temperatures to reduce the energy required for fixing, thereby achieving energy savings. Driven in part by demands for higher speed and higher image quality in image forming apparatuses, and further by the diversification of their usage purposes, the need for low temperature fixability of toners has been increasing. As a method of enhancing the low temperature fixability of toner, techniques using a combination of amorphous polyester resin and crystalline polyester resin are known.

### SUMMARY

The present disclosure described herein provides a toner that contains a toner particle containing a base toner particle containing a polyester resin, a release agent, and an aromatic petroleum resin, and an external additive including silica particles whose surfaces are at least partially coated with a hydroxide of a metal element, wherein, in a cross section of the toner particle observed with a scanning electron microscope, the aromatic petroleum resin is present at an interface of a domain of the release agent, and domains of the aromatic petroleum resin are dispersed within a matrix of the polyester resin.

As another aspect of the present disclosure, a developing agent is provided which contains the toner mentioned above and a carrier.

As another aspect of the present disclosure, a toner accommodating unit is provided which contains the toner mentioned above and a container accommodating the toner.

As another aspect of the present disclosure, an image forming apparatus is provided which contains an electrostatic latent image bearer, an electrostatic latent image forming device to form an electrostatic latent image on the electrostatic latent image bearer and a developing device to develop the electrostatic latent image formed on the electrostatic latent image bearer with the toner mentioned above to form a toner image and a transfer device to transfer the toner image onto a transfer body.

As another aspect of the present disclosure, an image forming method is provided which includes charging an electrostatic latent image bearer, forming an electrostatic latent image on the electrostatic latent image bearer that is charged, developing the electrostatic latent image with the toner mentioned above to form a toner image, transferring the toner image to a transfer body, cleaning the surface of the electrostatic latent image bearer with a cleaning device after the toner image is transferred, and fixing the toner image.

### BRIEF DESCRIPTION OF THE SEVERAL VIEWS OF THE DRAWINGS

A more complete appreciation of the disclosure and many of the attended advantages and features thereof can be readily obtained and understood from the following detailed description with reference to the accompanying drawings wherein: corresponding parts throughout and wherein

FIG. 1 is a cross section image of the toner of the present disclosure;

FIG. 2 is a cross section image of the toner of the present disclosure;

FIG. 3 is a schematic diagram illustrating an example of an image forming apparatus in the present disclosure;

FIG. 4 is a schematic diagram illustrating an example of the developing device for use in the present disclosure;

FIG. 5 is a diagram illustrating an example of the image forming apparatus including the developing device illustrated in FIG. 4;

FIG. 6 is a diagram illustrating another example of the image forming apparatus of the present disclosure; and

FIG. 7 is a diagram illustrating another example of the image forming apparatus of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more the features, integers, steps, operations, elements, components, and/or groups thereof.

Embodiments of the present invention are described in detail below with reference to accompanying drawings. In describing embodiments illustrates in the drawings, specific terminology is employed for the sake of clarity. However, the disclosure of this patent specification is not intended to be limited to the specific terminology so selected. And it is to be understood that each specific element includes all technical equivalents that have a similar function, operates in a similar manner, and achieve a smaller result.

For the sake of simplicity, the same reference number will be given to identical constituent elements such as parts and materials having the same functions and redundant descriptions thereof omitted unless otherwise stated.

Within the context of the present disclosure, it a first layer is stated to be “overlaid” on, or “overlying” a second layer, the first layer may be in direct contact with a portion or all of the second layer, or there may be one or more intervening layers between the first and second layer, with the second layer being close to the substrate than the first layer.

The present disclosure provides a toner that exhibits excellent low-temperature fixability, ensures long-term charging stability, achieves a balance between suppressing filming under severe conditions such as high temperature and humidity and maintaining releasability during fixing, and prevents occurrence of abnormal images over an extended period.

The toner of the present disclosure is described in detail below.

### Toner

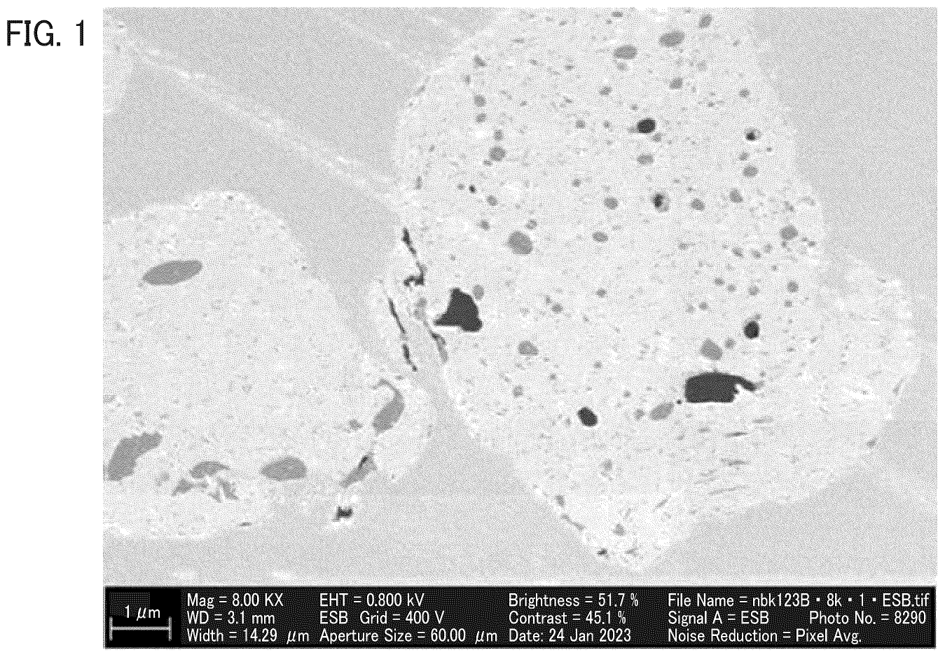

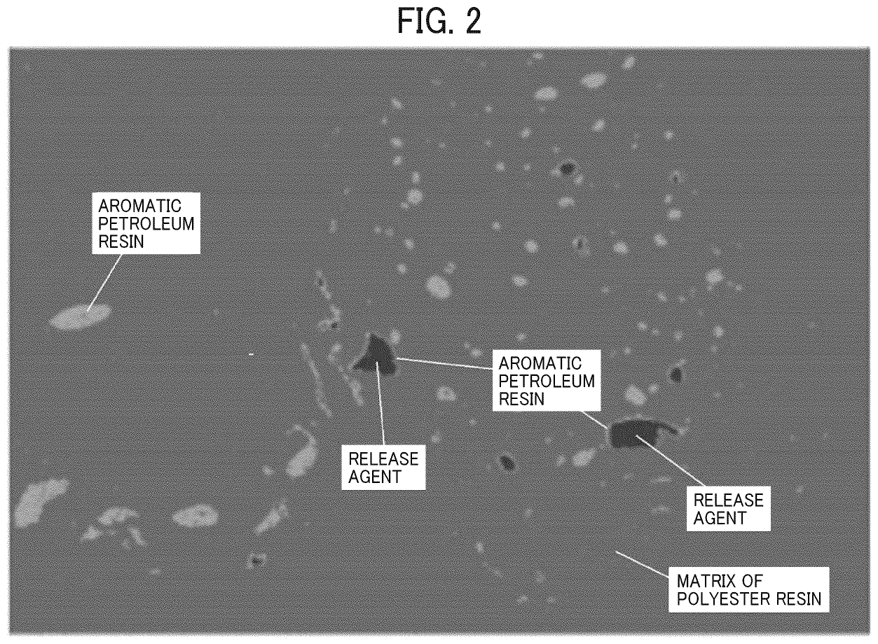

The toner of the present disclosure contains a toner particle that contains a base toner particle containing a polyester resin, a release agent, and an aromatic petroleum resin, and an external additive that contains silica particles whose surfaces are at least partially coated with a hydroxide of a metal element, wherein, in a cross section of the toner particle observed with a scanning electron microscope, as illustrated in FIGS. 1 and 2, the aromatic petroleum resin is present at an interface of a domain of the release agent, and domains of the aromatic petroleum resin are dispersed within a matrix of the polyester resin.

Moreover, the external additive includes silica particles whose surfaces are at least partially coated with a hydroxide of a metal element.

If release agent particles are present alone in the polyester resin (also hereinafter occasionally referred to as “binder resin”), fine toner particles containing a large amount of release agent or release agent components on the toner surface contaminate the carrier and the electrostatic latent image bearing member, causing toner scattering due to a decrease in charge caused by carrier spent, deterioration of background fouling, and filming of the electrostatic latent image bearing member. In particular, if continuous printing is performed under conditions where toner consumption is low due to a low image area ratio, problems have occurred, such as filming on the electrostatic latent image bearing member caused by adhesion of release agent components.

In contrast, because the toner of the present disclosure has the aromatic petroleum resin present at an interface of a domain of the release agent and domains of the aromatic petroleum resin dispersed within a matrix of the polyester resin, adhesion of release agent components to the electrostatic latent image bearing member during actual image formation is reduced, along with suppression of carrier spent and filming on the electrostatic latent image bearing member, while maintaining releasability during fixing, and in addition, charging stability is ensured over a long period and occurrence of abnormal images is prevented in the long term.

### Binder Resin

The toner particles of the present disclosure contain a polyester resin as a binder resin. The weight average molecular weight (Mw) is preferably 7,000 to 10,000, more preferably 7,500 to 9,500, and still more preferably 8,000 to 9,000. In addition, the weight average molecular weight (Mw)/the number average molecular weight (Mn) is at most 5 and preferably at most 4.

Any polyester resin obtained by polycondensation of a known alcohol and acid can be suitably used in the present disclosure.

Specific examples of alcohols include, but are not limited to, diols such as polyethylene glycol, diethylene glycol, triethylene glycol, 1,2-propylene glycol, 1,3-propylene glycol, diols, 1,4-propylene glycol, neopentyl glycol, neopentyl glycol, and 1, 4-butene diol; etherified bisphenols such as 1,4-bis(hydoroxymethyl)cyclohexane, bisphenol A, hydrogenated bisphenol A, polyoxyethyed bisphenol A, and polyoxypropylened bisphenol A; diol units in which these are substituted by saturated or unsaturated hydrocarbon groups having 3 to 22 carbon atoms; other diol units; tri- or higher alcohol monomers such as sorbitol, 1,2,3,6-hexanetetrol, 1,4-sorbitan, pentaerythritol, dipentaerythritol, tripentaerythritol, saccharose, 1,2,4-butane triol, 1,2,5-pentane triol, glycerol, 2-methylpropane triol, 2-methyl-1,2,4-butane triol, trimethylol ethane, trimethylol propane, 1,3,5-trihydroxy benzene.

Specific examples of carboxylic acids for use in preparation of polyester resins include, but are not limited to, monocarboxylic acids such as palmitic acid, stearic acid, and oleic acid; divalent organic acids such as maleic acid, fumaric acid, mesconic acid, citraconic acid, terephthalic acid, cyclohexane dicarboxylic acid, succinic acid, adipic acid, sebatic acid, and malonic acid, and divalent organic acid monomers in which these are substituted by saturated or unsaturated hydrocarbon groups having 3 to 22 carbon atoms; anhydrides of these acids; dimers of a lower alkyl ester and linoleic acid; 1,2,4-benzene tricarboxylic acid, 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylene carboxypropane, tetra(methylenecarboxyl) methane, 1,2,7,8-octane tetracarboxylic acid, Empol® trimer acid, and polycarboxylic acid monomer of anhydrides of these aids.

### Release Agent

The release agent mentioned above is not particularly limited and can be suitably selected according to a particular application.

Specific examples of such waxes include, but are not limited to, natural waxes including: vegetable waxes such as carnauba wax, cotton wax, Japan wax, and rice wax; animal waxes such as bee wax and lanolin; mineral waxes such as ozokerite; and petroleum waxes such as paraffin, microcrystalline, and petrolatum.

In addition to these natural waxes, synthesis hydrocarbon waxes such as Fischer-Tropsch wax, polyethylene wax, and polypropylene and synthesis wax such as ester, ketone, and ether are also usable.

Furthermore, fatty acid amide compounds such as 12-hydroxystearic acid amide, stearic acid amide, phthalic anhydride imide, and chlorinated hydrocarbons; homopolymers or copolymers of polyacrylates, such as poly-n-stearyl methacrylate and poly-n-lauryl methacrylate (for example, a copolymer of n-stearyl acrylate and ethyl methacrylate), which are crystalline polymer resins with a low molecular weight; and crystalline polymers with a long alkyl group in the side chain can also be used.

Among these, hydrocarbon waxes such as paraffin wax, microcrystalline wax, Fischer-Tropsch wax, polyethylene wax, and polypropylene wax are preferable to reduce the occurrence of filming.

Hydrocarbon waxes have limited compatibility with common polyester resins, causing them to migrate to the surface during fixing. This migration enhances releasability, resulting in improved gloss and excellent low-temperature fixability.

There is no specific limitation on the melting point of the release agent. The melting point can be set to a particular purpose and is preferably from 80 to 100 degrees Celsius. If the melting point is lower than 80 degrees Celsius, heat storage stability deteriorates, and if the melting point is higher than 100 degrees Celsius, low-temperature fixing performance deteriorates

The proportion of the release agent is not particularly limited and can be suitably selected according to a particular application. The number of parts of the release agent is preferably from 2 to 6 parts by mass and more preferably from 3 to 5 parts by mass per 100 parts of the toner. If the content is less than 2 parts by mass, migration of the release agent to the surface during fixing is insufficient, which leads to degradation of relesability, resulting in deterioration of low temperature fixability, and hot offset resistance. If the content exceeds 6 parts by mass, the amount of release agent precipitated on the toner surface increases, resulting in deterioration of storage stability and fluidity as toner, as well as worsening filming on an electrostatic latent image bearer and reduced conveyability of residual toner after transfer.

### Aromatic Petroleum Resin

As the aromatic petroleum resin for use in the present disclosure, styrene resins are preferable. Specific examples include, but are not limited to, polymers of styrene and its derivatives, such as polystyrene, poly-p-styrene, polyvinyltoluene, styrene-α-methylstyrene copolymer, styrene-p-chlorostyrene copolymer, styrene-propylene copolymer, styrene-vinyltoluene copolymer, styrene-methyl acrylate copolymer, styrene-ethyl acrylate copolymer, styrene-butyl acrylate copolymer, styrene-methyl methacrylate copolymer, styrene-ethyl methacrylate copolymer, styrene-butyl methacrylate copolymer, styrene-α-chloro methyl methacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-maleic acid copolymer, and styrene-maleic acid ester copolymer.

The glass transition temperature of the aromatic petroleum resin used in the present disclosure is preferably from 70 to 90 degrees Celsius, and more preferably from 75 to 85 degrees Celsius. If the glass transition temperature is lower than 70 degrees Celsius, the heat storage stability of the toner deteriorates, and if it is higher than 90 degrees Celsius, the low-temperature fixing performance deteriorates.

In the present disclosure, the glass transition temperature (Tg) is determined using a differential scanning calorimeter (DSC210, manufactured by Seiko Instruments Inc.). A sample of 0.01 g to 0.02 g is weighed into an aluminum pan, heated to 150 degrees Celsius, then cooled to 20 degrees Celsius at a cooling rate of 10 degrees Celsius/min. The cooled sample is subsequently heated at a heating rate of 10 degrees Celsius/min, and the glass transition temperature is defined as the intersection of the baseline extended below the highest endothermic peak and the tangent showing the maximum slope from the rising portion of the peak to its apex.

The content of the aromatic petroleum resin is not particularly limited and may be appropriately selected according to the intended purpose; however, it is preferably from 5 to 15 parts by mass per 100 parts by mass of the toner, more preferably from 5 to 10 parts by mass, and even more preferably from 7 to 10 parts by mass. If the content is less than 5 parts by mass, the grindability during toner pulverization decreases, resulting in reduced productivity of the pulverized toner. If the content exceeds 15 parts by mass, the low temperature fixing performance deteriorates.

### Colorant

Specific examples of the colorant include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and mixtures thereof. The content of a colorant is from 0.1 to 80 parts by mass per 100 parts by mass of a binder resin in general.

### External Additive

In the toner of the present disclosure, which contains an external additive covering the wax in the base toner particles, deterioration in transferability and durability caused by the wax can be suppressed.

In addition, since the toner surface is covered with fine particles of the external additive, the contact area between resins contained in the toner base particles is reduced, which improves the fluidity, storability, developability, transferability, and durability of the toner.

The external additive contained in the toner of the present disclosure includes silica particles (hereinafter occasionally referred to as ‘silica’) whose surface is at least partially coated with a hydroxide of a metal element. The inclusion of such silica as an external additive in the toner ensures charge stability and suppresses the occurrence of abnormal images.

The degree of hydrophobicity of the silica particles whose surface is at least partially coated with a hydroxide of a metal element is preferably at least 55 (MeOH percent). If the hydrophobicity of the silica is at least 55 (MeOH percent), appropriate cleaning performance is achieved and the occurrence of abnormal images is suspended.

The degree of hydrophobicity can be measured, for example, by the following method:

First, 50 mL of deionized water and a sample of 0.2 g are placed in a beaker, and methanol is added dropwise during stirring. As the methanol concentration in the beaker increases, the sample gradually settles, and the mass fraction of methanol in the methanol-water mixed solution at the endpoint where the entire amount has settled is defined as the hydrophobicity (MeOH percent).

In the present disclosure, the volume resistivity of silica particles whose surface is at least partially coated with a hydroxide of a metal element is from 2.0×10¹⁰ to 1.0×10¹¹ Ω·cm. When the volume resistivity is within the above range, the charge stability can be maintained at a high level over a long period.

The volume resistivity of silica particles whose surface is at least partially coated with a hydroxide of a metal element is preferably from 3.0×10¹⁰ to 7.0×10¹⁰ Ω·cm.

By setting the volume resistivity within this range, the charge stability can be maintained at an even higher level over a long period.

The volume resistivity of silica particles whose surface is at least partially coated with a hydroxide of a metal element can be measured, for example, by the following method.

First, in a cell composed of a fluororesin container accommodating two electrodes each having a surface area of 2.5 cm×4 cm and spaced 0.2 cm apart, the measurement sample is filled between the two electrodes and tapped 10 times at a tapping speed of 30 times per minute from a drop height of 1 cm. Next, a DC voltage of 1,000 V is applied between the two electrodes filled with the measurement sample, and the resistance value r [Ω] after 30 seconds is measured using a high-resistance meter (Model 4329A, manufactured by Yokogawa Hewlett-Packard Ltd.). The volume resistivity [Ω·cm] of the sample can then be calculated by substituting the measured resistance value r into the following Formula (1):

$$r \times ( 2.5 \times 4 ) / 0.2 \qquad Formula ( 1 )$$

The silica particles whose surface is at least partially coated with a hydroxide of a metal element preferably have their uppermost surface coated with an alkylsilane. This makes it easier to achieve both a hydrophobicity of not less than a certain level and a volume resistivity of not more than a certain level, thereby maintaining the charge stability and suppressing abnormal image formation at a higher level. The portion coated with the alkylsilane only needs to be partially coated. Examples of the alkylsilane include, for example, those exemplified in the section ‘Hydrophobizing Agents Used for Hydrophobizing Treatment’ described below.

The metal element used for forming the hydroxide at least partially coating the surface of the silica particles can be appropriately selected and is preferably selected from the group consisting of aluminum, zinc, magnesium, and iron, and more preferably from the group consisting of aluminum, zinc, and magnesium. Hydroxides of these metal elements make it easier to control the volume resistivity of the silica within a desired range.

Accordingly, the hydroxide of the metal element is preferably at least one hydroxides of a metal element selected from the group consisting of aluminum, zinc, magnesium, and iron, and more preferably from the group consisting of aluminum, zinc, and magnesium.

The average particle diameter of the silica whose surface is at least partially coated with a hydroxide of a metal element is preferably from 10 nm to 30 nm. If the average particle diameter of the silica is within the above range, the coating state on the toner surface is optimized, making it easier to strike a balance between low-temperature fixability and heat storage stability. The term ‘average particle diameter’ herein refers to a number average particle diameter.

The average particle diameter of the silica coated with a hydroxide of a metal element may be determined based on the average primary particle diameter of the silica before the silica is coated with the hydroxide of the metal element.

The average primary particle diameter of the silica particles is determined, for example, by acquiring a scanning electron microscope (SEM) image of the silica particles using a field-emission scanning electron microscope (Model SU8230, manufactured by Hitachi High-Tech Corporation) and measuring the number-average particle diameter by image analysis.

Specifically, for example, a sample of the silica particles is dispersed in tetrahydrofuran, the solvent is removed and dried on a substrate, and the sample is observed with the above SEM to acquire an image. Under the measurement conditions described below, the maximum length of each primary particle is measured for each particle. Then the average value of 50 particles is calculated to determine the average primary particle diameter of the silica particles.

### Measurement Conditions of SEM

Accelerating Voltage: 2.0 kV
WD (Working Distance): 5.0 mm
Magnification: 100000×

The toner of the present disclosure may contain, as external additives, other fine particles in addition to the silica whose surface is at least partially coated with a hydroxide of a metal element. The other fine particles may include one or more member selected from the group consisting of inorganic fine particles, oxide fine particles of inorganic substances, and resin fine particles.

The average primary particle diameter of the inorganic fine particles, oxide fine particles of inorganic substances, and resin fine particles is preferably from 5 nm to 2 μm. The content of the other fine particles in the toner, depending on the type, is preferably in the range of 0.01 to 5 percent by mass based on the toner.

The other fine particles preferably have a surface subjected to hydrophobizing treatment, and oxide fine particles of inorganic substances such as hydrophobized silica are preferably used.

Specific examples of such inorganic fine particles include, but are not limited to, silica, alumina, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. These can be used alone or in combination.

Specific examples of the resin fine particles include, but are not limited to, polystyrene, methacrylates, and acrylates obtained by soap-free emulsion polymerization, suspension polymerization, or dispersion polymerization, polycondensed particles such as silicone, benzoguanamine, and nylon, and polymer particles of thermocuring resin.

There is no specific limitation on the hyfrophobizing agent for use in the hydrophobizing treatment and it can be suitably selected according to a particular application.

Specific examples include, but are not limited to, dimethyldichlorosilane, trimethylchlorosilane, methyltrichlorosilane, aryldimethyldichlorosilane, arylphenyldichlorosilane, benzyldimethylmethylchlorosilane, bromomethyl dimethylchlorosilane, α-chloroethyltrichlorosilane, p-chloroethyltrichlorosilane, chlolomethyldimethylchlorosilane, chloromethyltrichlorosilane, p-chlorophenyl trichlorosilane, 3-chloropropyl trichlorosilane, 3-chloropropyl trimethoxysilane, vinyltriethoxysilane, vinylmethoxysilane, vinyl-tris(β-methoxyethoxy) silane, γ-methacryloxy propyltrimethoxysilane, vinyltriacetoxy silane, divinyldichlorosilane, dimethylvinyl chlorosilane, octyltrichlorosilane, decyltrichlorosilane, nonyl-trichlorosilane, (4-t-propylphenyl)-trichlorosilane, (4-t-butylphenyl)-trichlorosilane, dipentyl-dichlorosilane, dihexyl-dichlorosilane, dioctyl-dichlorosilane, dinonyl-dichlorosilane, didecyl-dichlorosilane, didodecyl-dichlorosilane, dihexadecyl-dichlorosilane, (4-t-butylphenyl)-octyl-dichlorosilane, dioctyl-dichlorosilane, didecenyl-dichlorosilane, dinonenyl-dichlorosilane, di-2-ethylhexyl-dichlorosilane, di-3,3-dimethylpentyl-dichlorosilane, trihexyl-chlorosilane, trioctyl-chlorosilane, tridecyl-chlorosilane, dioctyl-methyl-chlorosilane, octyl-dimethyl-chlorosilane, (4-t-propylphenyl)-diethyl-chlorosilane, octyl-dimethyl-chlosilane, hexamethyl disilazane,hexaethyl disilazane, diethyltetramethyl dislazane, hexaphenyl dislazane, hexatolyl disilazane, and hexatolyl disilazane.

In addition, titanate-based coupling agents and aluminum-based coupling agents can be also used.

The mixing of the above-mentioned external additive with the base toner particles is carried out using a general powder mixer. A mixer equipped with a jacket or others for adjusting the internal temperature is preferable. Examples of such mixers include, but are not limited to, a V-type mixer, a rocking mixer, a Lodige mixer, a Nauta mixer, and a Henschel mixer, which are preferably used.

The toner of the present disclosure preferably has an average circularity of 0.93 to 0.96.

### Developing Agent

In the case of using a two-component developing agent, specific examples of magnetic fine particles for use in the magnetic carrier include, but are not limited to, spinel ferrites such as magnetite and gamma ferric oxide, spinel ferrites containing one or two types of metals such as Mn, Ni, Zn, Mg, and Cu other than iron, magnetoplumbite type ferrites such as barium ferrite, and iron or alloyed metal particles with an oxidized layer on the surface. The magnetic carrier may have any form, such as a particulate form, a spherical form, or a needle-like form. In particular, it is preferable to use ferromagnetic fine particles, such as iron, to achieve strong magnetization. In addition, in terms of chemical stability, it is preferable to use spinel ferrite such as magnetite and gamma ferric oxide and magnetoplumbite type ferrite such as barium ferrite. A resin carrier with a desired magnetization can be used depending on the type and content of ferromagnetic fine particles. The carrier preferably has a magnetization of 30 to 150 emu/g at 1,000 Oersted.

Such resin carriers can be manufactured by spraying a melt-kneaded material of magnetized particulates and a binder resin having insulation property by a spray drier. Also, it is possible to manufacture resin carrier in which magnetized particulates are dispersed in a condensation type binder formed by reacting and curing monomers or prepolymers in an aqueous medium under the presence of magnetized particulates.

It is possible to control the chargeability of a magnetized carrier by fixating positively or negatively charged particulates or electroconductive particulates on the surface of the magnetized carrier or coating the magnetized carrier with a resin.

As the coating material for the surface of magnetized carrier, silicone resins, acrylic resins, epoxy resins, and fluorochemical resins are used. Furthermore, the surface thereof can be coated with a material containing positively or negatively charged particulates or electroconductive particulates. Among these, silicone resins and acrylic resins are preferable.

The mixing ratio of the toner of the present disclosure and magnetized carriers is preferably from 2 to 10 percent by mass as toner concentration.

The weight average molecular weight of the toner is preferably from 2 to 10 μm.

The particle size of the toner is measured by various methods. For example, using a Coulter Counter Multisizer III, a measurement sample is prepared by adding the toner to an electrolytic solution containing a surfactant and dispersing it for one minute with an ultrasonic disperser, and the dispersed sample is then used to measure 50,000 particles.

To produce the toner of the present disclosure, a fixing resin, lubricant, optionally colorant, and furthermore optionally a fixing resin which a charge control agent, lubricant, and additives are uniformly dispersed are combined and thoroughly mixed using a mixer such as a Henschel mixer or a super mixer. The mixture is then melt-kneaded using a thermal melt-kneading machine such as heated rolls, a kneader, or an extruder to sufficiently mix the materials. After cooling and solidification, the mixture is finely pulverized and classified to obtain the toner. As the pulverization method, it is possible to employ a jet mill method of adding toner to a jet air followed by collision with a collision board to pulverize the toner using its collision energy, an interparticle collision method of colliding toner particles in an air stream, or a mechanical pulverization method of supplying toner into a narrow gap with a rotor rotating at high speed.

### Image Forming Apparatus and Image Forming Method

The image forming apparatus of the present disclosure preferably includes an electrostatic latent image bearer, an electrostatic latent image forming device for forming an electrostatic latent image on the electrostatic latent image bearer, a developing device for developing the electrostatic latent image on the electrostatic latent image bearer with the toner of the present disclosure to form a toner image, a transfer device for transferring the toner image onto the surface of a printing medium, and a fixing device for fixing the toner image on the surface of the printing medium. It optionally includes other devices such as a discharging (quenching) device, a cleaning device, a recycling device, and a control device.

The image forming method of the present disclosure preferably includes forming an electrostatic latent image on an electrostatic latent image bearer, developing the electrostatic latent image formed on the electrostatic latent image bearer with the toner of the present disclosure to form a toner image, transferring the toner image formed on the electrostatic latent image bearer to the surface of a printing medium, and fixing the toner image transferred to the surface of the printing medium. It may optionally include processes such as discharging (quenching), cleaning, recycling, and controlling.

Electrostatic latent image Forming Process and Electrostatic latent image Forming Device

In the forming an electrostatic latent image, an electrostatic latent image is formed on an electrostatic latent image bearer.

The electrostatic latent image forming device forms an electrostatic latent image on the electrostatic latent image bearer.

The electrostatic latent image forming process can be suitably executed by the electrostatic latent image device.

There is no specific limitation on the electrostatic latent image bearer (also referred to as electrophotographic photoconductor, photocondcutor, or photoreceptor) with regard to material, form, structure, size, etc. And any known electrostatic latent image bearer can be suitably selected. An electrostatic latent image bearer having a drum-like form is preferable. Also, for example, an inorganic photoconductor made of amorphous silicone or selenium and an organic photoconductor (OPC) made of polysilane or phthalopolymethine are suitable.

One example of the organic photoconductor is a layered photoconductor, including layers-a charge-generation layer formed of a non-metallic material like phthalocyanine, or titanyl phthalocyanine dispersed in a binder resin and a charge-transport layer formed of a charge transport material dispersed in a binder resin-stacked on a substrate such as an aluminum drum.

Another type is a single-layer photoconductor with a single-layer structure on a substrate, featuring a photosensitive layer formed of both charge-generation and a charge-transport material dispersed in a binder resin.

In the single-layer photoconductor, hole transport agents and electron transport agents can be added to the photosensitive layer as charge transport materials.

Additionally, an undercoat layer may be provided between the substrate and either the multi-layered charge generation layer or the single-layered photosensitive layer.

Electrostatic latent images are formed by, for example, uniformly charging the surface of the electrostatic latent image bearer and irradiating the surface according to the obtained image information.

The electrostatic latent image forming device preferably includes at least a charger serving as a charging device for uniformly charging the surface of the electrostatic latent image bearer and an irradiator serving as an irradiating device for irradiating the surface of the electrostatic latent image bearer with light according to the obtained image information.

Charging is carried out, for instance, by applying a bias to the surface of the image bearer using the charging device.

The charging device (charger) is not particularly limited and can be suitably selected according to a particular application.

Specific examples include, but are not limited to, a known contact type charger that includes an electroconductive or semiconductive roll, brush, film, or a rubber blade, and a non-contact type charger using corona discharging such as corotron and scorotron.

Preferably, the charger is disposed in contact or non-contact with the electrostatic latent image bearer and applies a direct voltage and an alternating voltage superimposed thereon to the surface of the electrostatic latent image bearer. The charger is preferably a charging roller disposed in contact with the electrostatic latent image bearer with a gap tape therebetween. It is preferable that the charging roller apply a direct voltage on which an alternate voltage is superimposed to charge the surface of the electrostatic latent image bearer.

The irradiation is conducted by, for example, irradiating the surface of the electrostatic latent image bearer with the irradiator.

The irradiator is not particularly limited and it can be suitably selected according to a particular application as long as it can irradiate imagewise the surface of the electrostatic latent image bearer charged by the charger.

Specific examples of such irradiators include, but are not limited to, a photocopying optical system, a rod lens array system, a laser optical system, and a liquid crystal shutter optical system.

In the present disclosure, a dorsal irradiation system can be employed, where the electrostatic latent image bearer is irradiated from the rear side in an imagewise manner.

### Developing Process and Developing Device

In the developing process, electrostatic latent images formed on the electrostatic latent image bearer are developed with the toner to form toner images.

The developing unit is to develop an electrostatic latent image formed on the electrostatic latent image bearer with the toner to form a toner image.

The developing process can be suitably conducted by the developing device.

The toner image can be formed by, for example, developing the electrostatic latent image with the toner.

The developing device preferably includes a developing unit for accommodating toner and supplying it to the electrostatic latent image in either a contact or non-contact manner. The developing unit preferably includes a toner container.

The developing unit is either a single color developing unit or a multi-color developing unit. The developing unit suitably includes, for example, a stirrer to triboelectrically charge the toner and a rotatable magnet roller.

### Transfer Process and Transfer Device

In the transfer process, the toner image formed on the electrostatic latent image bearer is transferred onto the surface of a recording medium.

The transfer device transfers the toner image formed on the electrostatic latent image bearer onto the surface of a recording medium.

The transfer process can be suitably conducted by the corresponding transfer device.

In the transfer process mentioned above, the visible image mentioned above is transferred to a printing medium. Preferably, the toner image is primarily transferred to an intermediate transfer member and thereafter secondarily transferred to the printing medium. It is more preferable that, with a two-color toner, preferably a full color toner, the toner image be primarily transferred to the intermediate transfer member to form a complex transfer image and the complex transfer image be thereafter secondarily transferred to the printing medium.

The transfer device (the primary transfer device and the secondary transfer device mentioned above) preferably includes a transfer unit for peeling-charge the toner image formed on the electrostatic latent image bearer or photoconductor to peel the image to the printing medium. One or more transfer devices can be provided. Specific examples of the transfer device include, but are not limited to, a corona transfer device using corona discharging, a transfer belt, a transfer belt, a transfer roller, a pressure transfer roller and an adhesive transfer device.

The transfer member is not particularly limited and can be suitably selected from the known printing media, typically printing paper.

### Fixing Process and Fixing Device

In the fixing process, the toner image transferred to the surface of a recording medium is fixed thereon.

The fixing device fixes the toner image transferred to the surface of the recording medium.

The fixing process can be suitably conducted by a corresponding fixing device.

The fixing process can be executed every time each color toner image is transferred to a recording medium. Alternatively, the fixing process can be conducted for a multi-color superimposed toner image.

There is no specific limitation on the fixing device and it can be suitably selected according to a particular application. Using a known heat-pressing device is preferable. The heat-pressing device includes, but is not limited to, a combination of a heating roller and a pressing roller or a combination of a heating roller, a pressing roller, and an endless belt can be suitably used.

### Discharging Process and Discharging Device

In the discharging process (charge removal process, quenching process), a discharging bias (a charge removal bias) is applied to the electrostatic latent image bearer to remove the charge thereon.

The discharging device (charge removal device, quenching device) is to remove the charge on the electrostatic latent image bearer by applying a charge removal bias thereto.

The discharging process can be suitably conducted by a corresponding discharging device.

The discharging device is not particularly limited as long as it can apply a discharging bias to the electrostatic latent image bearer. It can be selected among the known discharging devices. One such device is a discharging lamp.

### Cleaning Process and Cleaning Device

In the cleaning process, toner remaining on the surface of the electrostatic latent image bearer is removed.

The cleaning device is to remove the toner remaining on the surface of the electrostatic latent image bearer.

The cleaning process can be suitably conducted by a corresponding cleaning device.

As the cleaning device, any known cleaner that can remove the toner remaining on the surface of the electrostatic latent image bearer is suitable. For example, a magnetic brush cleaner, an electrostatic brush cleaner, a magnetic roller cleaner, a blade cleaner, a brush cleaner, and a web cleaner are preferable.

### Recycling Process and Recycling Device

In the recycling process, the toner removed in the cleaning process mentioned above is returned to the developing device for re-use.

The recycling device is to return the toner removed by the cleaning device mentioned above to the developing device for re-use. There is no specific limitation on the recycling device and any devices including known conveying device can be used.

The recycling process can be suitably conducted by a corresponding recycling device.

### Control Process and Control Device

In the control process, each of the processes described above is controlled.

The control device controls each of the aforementioned devices.

The control process can be suitably conducted by a corresponding controlling device.

The controlling device (controller) is not particularly limited and can be suitably selected to according to a particular application as long as it can control the behavior of each device. Specific examples include, but are not limited to, a sequencer and a computer.

### Method of Producing Printed Matter

The method of producing printer matter of the present disclosure preferably forms printed matter on recording media using an electrostatic latent image bearer, an electrostatic latent image forming device for forming an electrostatic latent image on the electrostatic latent image bearer, a developing device for developing the electrostatic latent image on the electrostatic latent image bearer with toner to form a toner image, a transfer device for transferring the toner image onto the surface of a printing medium, and a fixing device for fixing the toner image on the surface of the recording medium. The method may optionally include other optional processes.

The printed matter mentioned above includes a recording medium and an image formed on the recording medium with the toner of the present disclosure.

Since each process in the method of producing printed matter can use the same techniques as the aforementioned image forming method, redundant explanations are omitted.

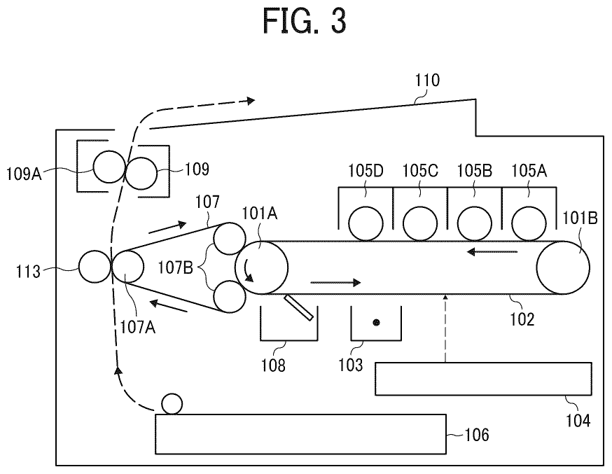

FIG. 3 is a diagram illustrating an example of the electrophotographic imaging device (image forming apparatus).

In FIG. 3, the image forming apparatus includes a drive roller 101A, a driven roller 101B, a photoconductor belt 102, a charger 103, a laser writing (drawing) unit 104, each of developing units 105A, 105B, 105C, and 105D to accommodate each color toner of yellow, magenta, cyan, and black, a sheet feed cassette 106, an intermediate transfer belt 107, a drive shaft roller 107A to drive the intermediate transfer belt 107, a driven shaft roller to support the intermediate transfer belt 107, a cleaner 108, a fixing roller 109, a pressure roller 109A, an ejection tray 110, and a sheet transfer roller 113.

In this color image forming apparatus, the intermediate transfer belt 107 is flexible as the intermediate transfer body The intermediate transfer belt 107 serving as the intermediate transfer body is circularly conveyed clockwise while being stretched over the drive shaft roller 107A and a pair of the driven shaft rollers 107B. The belt surface between the pair of the driven shaft rollers 107B is brought into contact with the photoconductor belt 102 at the outer circumference of the drive roller 101A.

During normal color image output, each color toner image formed on the photoconductor belt 102 is transferred to the intermediate transfer belt 107 each time it is formed, thereby combining the color toner images. The combined toner image is then collectively transferred onto a transfer sheet, which is conveyed from the sheet feed cassette 106, by the sheet transfer roller 113. After the transfer, the transfer sheet is conveyed to the space between the fixing roller 109 and the pressure roller 109A of the fixing device, and after being fixed by the fixing roller 109 and the pressure roller 109A, the paper is discharged to the ejection tray 110.

When the developing units 105A to 105D develop the latent image with toner, the toner concentration of the developing agent contained in the developing units decreases. The decrease in toner concentration of the developing agent is detected by a toner concentration sensor. When a decrease in toner concentration is detected, a toner replenishing device connected to each developing unit operates to replenish toner and increase the toner concentration. At this time, the replenished toner may be a developing agent for a so-called trickle development method, in which carrier and toner are mixed, provided that the developing unit is equipped with a developing agent ejection mechanism.

In FIG. 3, the toner images of respective colors are superimposed on the intermediate transfer belt 107 to form a color toner image. Also, the image forming apparatus of the present disclosure includes a configuration in which the toner images are directly transferred from the photoconductor belt 102 to a recording medium without using intermediate transfer belt 107.

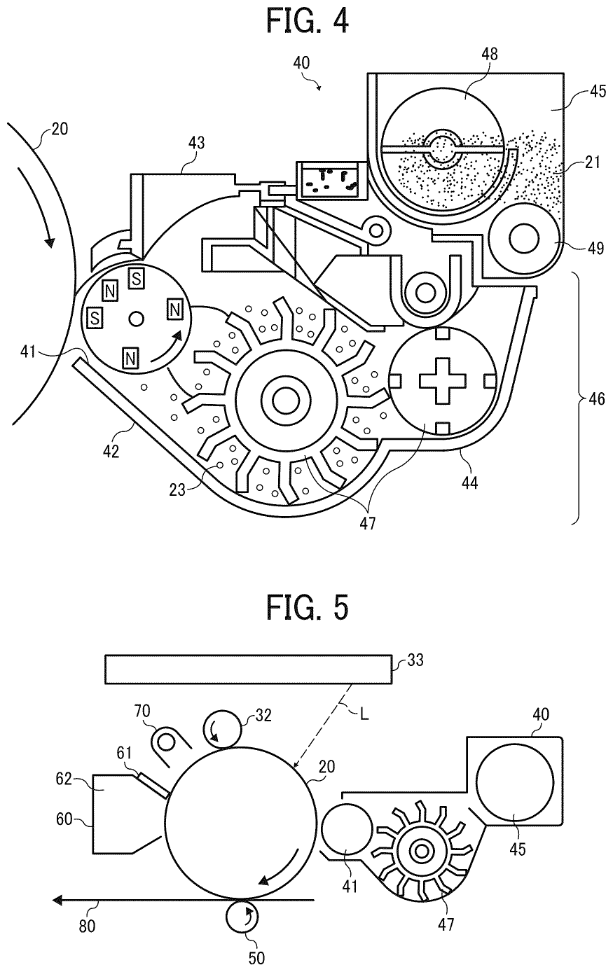

FIG. 4 is a schematic diagram illustrating an example of the developing device for use in the present disclosure and the following variations are within the scope of the present disclosure.

The developing device 40 illustrated in FIG. 4 is disposed facing the photoconductor 20 serving as an electrostatic latent image bearer. The developing device 40 includes a development sleeve 41 serving as a developing agent bearer, a developing agent accommodating member 42, a doctor blade 43 serving as a regulating member, a supporting housing 44, and others.

To the supporting housing 44 having an aperture on the side of the photoconductor 20, a toner hopper 45 serving as a toner accommodating unit to accommodate a toner 21 inside is jointed. A developing agent accommodating unit 46 accommodating a developing agent including the toner 21 and a carrier 23 is disposed adjacent to the toner hopper 45. The developing agent accommodating unit 46 includes a developing agent stirring mechanism 47 for stirring the toner 21 and the carrier 23 to triboelectrically charge and peeling-charge the toner 21.

Inside the toner hopper 45, a toner agitator 48, which serves as a toner supplying device rotationally driven by a drive device, and a toner replenishment mechanism 49 are provided. The toner agitator 48 and the toner replenishment mechanism 49 send out the toner 21 in the toner hopper 45 towards the developing agent accommodating unit 46 while stirring.

The development sleeve 41 is disposed at the space between the photoconductor 20 and the toner hopper 45. The development sleeve 41 rotationally driven by the drive device in the direction indicated by an arrow includes a magnet inside serving as a magnetic field generating device. The magnet is disposed and fixed relatively to the developing device 40 to form a magnetic brush of the carrier 23.

The doctor blade 43 is integrally mounted with the developing agent accommodating member 42 on the other side of the supporting housing 44, facing the developing agent accommodating member 42. In this example, the doctor blade 43 is disposed with a constant gap between the front end of the doctor blade 43 and the outer periphery of the development sleeve 41.

Using such a device in a non-limiting manner, the image forming method of the present disclosure is carried out as follows.

That is, by the above configuration, the toner 21 delivered from inside the toner hopper 45 by the toner agitator 48 and the toner replenishment mechanism 49 is conveyed to the developing agent accommodating unit 46, where it is agitated by the developing agent stirring mechanism 47 so that a desired friction and peeling-charge is imparted. Together with the carrier 23, the toner functions as a developing agent, is bore on the development sleeve 41, and transferred to a position facing the outer peripheral surface of the photoconductor 20. There, only the toner 21 electrostatically couples with the electrostatic latent image formed on the photoconductor 20, thereby forming a toner image on the photoconductor 20.

FIG. 5 is a diagram illustrating an example of the image forming apparatus including the developing device illustrated in FIG. 4. Around the drum-shaped photoconductor 20, a charging member 32, an image irradiating system 33, a developing device 40, a transfer device, a cleaning device 60, and a discharge lamp 70 are arranged. In this example, the surface of the charging member 32 is in a non-contact state with a gap of about 0.2 mm from the surface of the photoconductor 20. When charging the photoconductor 20 by the charging member 32, the photoconductor 20 is charged by an electric field in which an AC component is superimposed on a DC component by a voltage applying device to the charging member 32, thereby making it possible and effective to reduce uneven charging. The image forming method, including the developing method, is performed by the following operations.

A series of the image forming processes are described using a negative-positive process. The photoconductor 20 represented by an organic photoconductor (OPC) including an organic photoconductive layer is discharged by the discharging lamp 70, uniformly and negatively charged by the charging member 32 such as a charger and a charging roller, irradiated with a laser beam emitted from the image irradiating system 33 of a system such as a laser optical system to form an electrostatic latent image (the absolute value of the irradiated site voltage is lower than the absolute value of the non-irradiated site voltage in this example).

The laser beam is emitted from a semiconductor laser and scans the surface of the photoconductor 20 in the rotation axis direction of the photoconductor 20 by the light reflected at, for example, a polygon mirror having a polygonal column rotating at a high speed. The thus-formed latent image is developed by a mixture of toner and carrier supplied onto the development sleeve 41 serving as a developing agent bearer included in the developing device 40, resulting in formation of a toner image. During development of the latent image, a developing bias of a DC voltage of an appropriate magnitude or this DC voltage superimposed with an AC voltage is applied to the development sleeve 41 from a voltage applying mechanism, between the exposed and unexposed areas of the photoconductor 20.

A recording medium (typically, paper) 80 is fed from a sheet feeding mechanism between the photoconductor 20 and the transfer device 50 in synchronization with the front end of the image at a pair of registration rollers to transfer the toner image. It is preferable that a voltage having a polarity reversed to that of the toner charging be applied to the transfer device 50 as a transfer bias. Thereafter, the recording medium 80 is separated from the photoconductor 20 to obtain a transfer image.

In addition, the toner remaining on the photoconductor 20 is retrieved into a toner retrieving chamber 62 in the cleaning device 60 by the cleaning blade 61 serving as a cleaning member.

It is possible to convey the retrieved toner to either or both of the developing agent accommodating unit 46 and the toner hopper 45 by a toner recycling device for reuse.

The image forming apparatus includes a plurality of the developing devices described above to sequentially transfer the toner images to the recording medium. Thereafter, the recording medium is conveyed to a fixing mechanism. The fixing mechanism may fix the toner with heat. Alternatively, the plurality of the toner images are temporarily transferred to an intermediate transfer body and thereafter the thus-obtained toner image is transferred to the recording medium followed by fixing as described above.

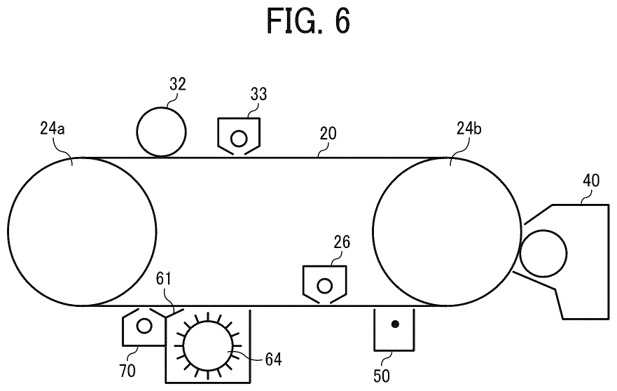

FIG. 6 is a diagram illustrating another example of the image forming apparatus for use in the present disclosure. The photoconductor 20 includes at least a photosensitive layer on an electroconductive substrate. The photoconductor 20 is driven by a drive rollers 24a and 24b, charged by the charging member 32, irradiated by the image irradiating system 33, developed by the developing device 40, transferred by the transfer device 50, irradiated with a pre-cleaning irradiating light source 26, cleaned by a brush cleaning device 64 and the cleaning blade 61, and discharged by the discharging lamp 70. In FIG. 6, the pre-cleaning irradiating light source 26 irradiates the photoconductor 20 from the substrate side thereof because the photoconductor 20 is transmissive in this case.

The image forming apparatus of the present disclosure includes an electrostatic latent image bearer, an electrostatic latent image forming device, a development device, and other optional devices.

The image forming method of the present disclosure includes forming an electrostatic latent image, developing the electrostatic latent image, and other optional processes.

The image forming method can be suitably conducted by the image forming apparatus. The electrostatic latent image can be suitably formed with the electrostatic latent image forming device. The electrostatic latent image can be suitably developed with the developing device. The other optional processes can be suitably conducted by the corresponding other optional devices.

The image forming apparatus more preferably includes an electrostatic latent image bearer, an electrostatic latent image forming device for forming an electrostatic latent image on the electrostatic latent image bearer, a developing device for developing the electrostatic latent image on the electrostatic latent image bearer with toner to form a toner image, a transfer device for transferring the toner image onto the surface of a recording medium, and a fixing device for fixing the toner image on the surface of the recording medium.

More preferably, the image forming method includes forming an electrostatic latent image on an electrostatic latent image bearer, developing the electrostatic latent image formed on the electrostatic latent image bearer with toner to form a toner image, transferring the toner image formed on the electrostatic latent image bearer to the surface of a recording medium, and fixing the toner image transferred to the surface of the recording medium.

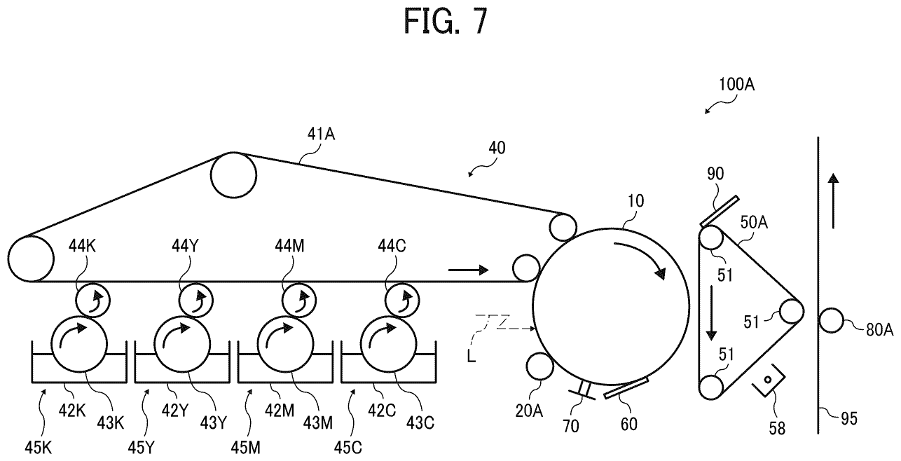

An aspect of the image forming apparatus of the present disclosure is described with reference to FIG. 7. A color image forming apparatus 100A illustrated in FIG. 7 includes a drum photoconductor 10 (hereinafter, also referred to as photoconductor 10) as the electrostatic latent image bearer, a charging roller 20A as the charging device, an irradiator 30 as the exposing device, a developing device 40 as the developing device, an intermediate transfer body 50A, a cleaning device 60 as the cleaning device having a cleaning blade, and a discharging lamp 70 as the discharging device.

The intermediate transfer body 50A is a belt having an endless form and is designed to be movable in the direction indicated by the arrow by three rollers 51, which are disposed inside the intermediate transfer body 50A and stretches the intermediate transfer body 50A. The three rollers 51 partially serves as a transfer bias roller to apply a particular transfer bias (primary transfer bias) to the intermediate transfer body 50A. Around the intermediate transfer body 50A is disposed a cleaning device 90 equipped with a cleaning blade. Around the intermediate transfer body 50A, a transfer roller 80A is disposed as the transfer device capable of applying a transfer bias to transfer (secondary transfer) a developed image (toner image) onto a transfer sheet 95 as a recording medium while facing the intermediate transfer body 50A. Around the intermediate transfer body 50A, a corona charger 58 to apply charges to the toner image on the intermediate transfer body 50A is disposed between the contact portion of the photoconductor 10 and the intermediate transfer body 50A and the contact portion between the intermediate transfer body 50A and the transfer sheet 95 along the rotation direction of the intermediate transfer body 50A.

The intermediate transfer body 50A may also include an elastic intermediate transfer belt. The elastic intermediate transfer belt can have a structure in which a flexible elastic layer is laminated on a rigid base layer that exhibits relatively good flexibility.

Additionally, to prevent the intermediate transfer body 50A from meandering, a guide member may be provided on its inner peripheral surface.

A collecting device for receiving toner and others removed by the intermediate transfer body cleaning device 90 may be provided. A structure such as a dish-shaped tray can be used as the collecting device.

The developing device 40 includes a developing belt 41A as the developing agent bearer, a black (K) developing unit 45K, a yellow (Y) developing unit 45Y, a magenta (M) developing unit 45M, a cyan (C) developing unit 45C, all of which are disposed around the developing belt 41A. The black developing unit 45K includes a developing agent accommodating unit 42K, a developing agent supplying roller 43K, and a developing roller 44K. The yellow developing unit 45Y includes a developing agent accommodating unit 42Y, a developing agent supplying roller 43Y, and a developing roller 44Y. The magenta developing unit 45M includes a developing agent accommodating unit 42M, a developing agent supplying roller 43M, and a developing roller 44M. The cyan developing unit 45C includes a developing agent accommodating unit 42C, a developing agent supplying roller 43C, and a developing roller 44C. Further, the developing belt 41A takes an endless form, stretched around a plurality of belt rollers in a rotatable manner, and partially contacts with the electrostatic latent image bearer 10.

The image forming method is specifically described below.

Image data sent to an image processing unit (hereinafter referred to as IPU) form image signals for each of four colors of yellow (Y), magenta (M), cyan (C), and black (K).

Thereafter, the image processing unit transmits each image signal of Y, M, C, K to a writing unit 15. The writing unit modulates and scans the four laser beams for Y, M, C, and K, and the charging unit charges a drum photocondcutor to sequentially form electrostatic latent images thereon. For example, the first drum photoconductor, the second drum photoconductor, the third drum photoconductor, and the fourth drum photoconductor, respectively correspond to K, Y, M, and C.

Next, the developing unit as the developing device forms each color toner images on the drum photoconductor. In addition, the transfer sheet fed by the sheet feeding unit is conveyed on a transfer belt. The toner images on the drum photoconductors are sequentially transferred to the transfer sheet by transfer chargers.

After this transfer process, the transfer sheet is conveyed to a fixing unit, where the transferred toner image is fixed on the transfer sheet.

After the completion of the transfer system, the toner remaining on the drum photoconductor is removed by the cleaning device.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight rations in parts, unless otherwise specified.

### EXAMPLES

The present disclosure is described in detail based on the following Examples.

It is to be noted that it will be apparent to one of ordinary skill in the art that many suitable changes and modifications can be made to the Examples of the present invention described below to make other embodiments, these changes and modifications are within the scope of the present invention, and the following descriptions are merely examples in preferable embodiments of the present invention and are not limiting.

In the following Examples and Comparative Examples, “parts” represents “parts by mass” and, “percent”, “percent by mass”, unless otherwise specified.

Methods of evaluating of properties of binder resins, toner, and release agent are described.

### Measurement of Glass Transition Temperature (Tg) of Binder Resin

In the present disclosure, the glass transition temperature (Tg) was determined using a differential scanning calorimeter (DSC210, manufactured by Seiko Instruments Inc.). A sample of 0.01 g to 0.02 g was weighed into an aluminum pan, heated to 200 degrees Celsius, then cooled to 20 degrees Celsius at a cooling rate of 10 degrees Celsius/min. The cooled sample was subsequently heated at a heating rate of 10 degrees Celsius/min, and the glass transition temperature was defined as the intersection of the baseline extended below the highest endothermic peak and the tangent showing the maximum slope from the rising portion of the peak to its apex.

### Measuring of Acid Value of Toner and Binder Resin

The acid value of a toner and a binder resin was measured under the following condition according to the method described in JIS K0070-1992 (Test methods for acid value, saponification value, ester value, iodine value, hydroxyl value and unsaponifiable matter of chemical products).

Sample preparation: 0.5 g of toner (0.3 g as portion soluble in ethyl acetate) was added to 120 mL of toluene and dissolved therein by stirring at room temperature (23 degrees Celsius) for about 10 hours.

Then 30 ml of ethanol was added to prepare a sample solution.

The acid value can be calculated based on the above-mentioned JIS K0070-1992 and is specifically obtained as follows.

Titration is conducted using preliminarily set alcohol solution of N/10 potassium hydroxide and the acid value is obtained by the following relation based on the consumed amount of the alcohol solution of potassium:

$$Acid value : KOH ( mL number ) \times f \times 56.1 / sample mass ( f represents a factor of N / 10 KOH )$$

Since only one type of binder resin was used in the following Examples and Comparative Examples, the acid values of the binder resin and the toner almost matched.

### Hydroxyl Value of Toner and Binder Resin

The hydroxyl value of a toner and a binder resin was measured under the following condition according to the measurement method described in JIS K0070-1992 mentioned above.

### Sample Preparation

(1) Preparation of 0.5 mol/L Potassium Hydroxide Titration Solution

Forty g of potassium hydroxide was dissolved in 50 mL of deionized water. Then 10 mL of the supernatant of the prepared potassium hydroxide solution was discarded, followed by adding methanol to make the total volume of 1000 mL.
(2) Preparation of Liquid Mixture of Methanol and Acetone

One litter of methanol and 1 L of acetone were mixed, followed by adding one drop of BTB reagent and 30 mL of PP indicator, and then adding 0.1 mol/L potassium hydroxide methanol solution until a faint reddish-purple color appeared.
(3) Five gram of toner was accurately weighed into a conical flask, 5 mL of a liquid mixture of acetic anhydride/pyridine (1:4) was added using a volumetric pipette, and 25 mL of pyridine was added using a graduated cylinder. A reflux condenser was attached, and the mixture was reacted in an oil bath at 98 degrees Celsius for 1.5 hours.
(4) Three milliliter of deionized water was added from the top of the condenser, followed by heating in the oil bath for an additional 10 minutes.
(5) The conical flask was removed from the oil bath and cooled to room temperature. The condenser was washed with acetone and then removed.
(6) Fifty milliliter of tetrahydrofuran was added using a graduated cylinder, and 10 drops of PP indicator were added. Titration was performed using the 0.5 mol/L potassium hydroxide titration solution prepared in step (1). Near the endpoint, 25 mL of the liquid mixture of methanol and acetone prepared in step (2) was added, and titration was continued. The endpoint was defined as the point where a faint red color persisted for 30 seconds to determine the titration volume.
(7) The operations in steps (3) to (6) were performed without the sample as a blank test.
(8) The hydroxyl value was calculated using the following formula:

$$Hydroxyl value = [ ( B - A ) \times f \times 28.05 / S ] + Acid value , where$$

$$A : Titration volume of 0.5 mol / L potassium hydroxide solution required for the main test$$

$$B : Titration volume of 0.5 mol / L potassium hydroxide solution required for the blank test$$

$$f : Factor of the 0.5 mol / L potassium hydroxide titration solution$$

$$S : Sample weigth ( g )$$

### Measurement of Molecular Weight of Binder Resin

The number average molecular weight and the weight average molecular weight of the binder resin was obtained by measuring the molecular weight distribution of the portion of the toner dissolved in tetrahydrofuran (THF) with a gel permeation chromatography (GPC) measuring instrument (GPC-150C, available from Waters Corporation).

Measuring was carried out using a column (KF801 to 807, available from SHOWA DENKO K.K) as follows. The column was stabilized in a 40 degrees Celsius heat chamber followed by the passage of THF as a solvent through the column at 1 mL/min at this temperature. Thereafter, 0.05 g of a sample was sufficiently dissolved in 5 g of THF followed by filtering by a filter as preprocessing (Chromatodisc having hole diameter of 0.45 μm, manufactured by Kurabo Industries Ltd.). In the end, the filter was adjusted in such a manner that the sample concentration was from 0.05 to 0.6 percent by mass and 50 to 200 μL of the THF sample solution was infused for measuring. The weight average molecular weight Mw and the number average molecular weight Mn of the sample portion dissolved in THF were calculated based on the relationship between the count values and the logarithm values of the calibration curves made from several types of monodispersed polystyrene standard samples.

As the standard polystyrene sample for the standard curve, polystyrene samples having a molecular weight of 6×10², 2.1×10², 4×10², 1.75×10⁴, 5.1×10⁴, 1.1×10⁵, 3.9×10⁵, 8.6×10⁵, 2×10⁶, or 4.48×10⁶, available from Pressure Chemical Co. Or TOSOH CORPORATION were used. Using at least about 10 standard polystyrene samples was appropriate, so these samples are used. In addition, a refractive index (RI) detector is used as the detector.

### Measurement of Melting Point of Wax

Using a differential scanning calorimeter (DSC 210, manufactured by Seiko Instruments Inc.), 0.01 to 0.02 g of the sample was weighed into an aluminum pan, heated to 150 degrees Celsius at a heating rate of 10 degrees Celsius/min, and the temperature at the maximum endothermic peak was determined as the melting point.

Next, methods of producing polyester resin, the base toner particles, and the inorganic external additive are described.

### Preparation of Polyester Resin

A monomer was prepared by blending polyoxypropylene (2.2)-2,2-bis(4-hydroxyphenyl) propane as the aromatic diol component accounted for 40 percent by mol, ethylene glycol for 60 percent by mol, adipic acid for 40 percent by mole, terephthalic acid for 20 percent by mol, isophthalic acid for 20 percent by mol and trimellitic acid for 20 percent by mol.

The resulting monomer, in a total amount of 4000 g, was charged into a 5 L autoclave equipped with a distillation column and subjected to esterification reaction under atmospheric pressure at 170 to 260 degrees Celsius without a catalyst.

Thereafter, 400 ppm of antimony trioxide, relative to the total carboxylic acid components, was added to the reaction system, and polycondensation was conducted at 250 degrees Celsius under a vacuum of 3 Torr while removing the glycol from the system, thereby obtaining [Polyester Resin 1]. The crosslinking reaction was continued until the stirring torque reached 10 kg cm (100 ppm), and the reaction was terminated by releasing the reduced pressure inside the reactor. The [Polyester Resin 1] obtained had a glass transition temperature of 58.9 degrees Celsius, an acid value of 9.6 mgKOH/g, a weight average molecular weight (Mw) of 7,220, a number average molecular weight (Mn) of 2,490, and an Mw/Mn ratio of 2.9.

### Preparation of Polyol Resin

A polyol resin was prepared by charging 1000 g of a low molecular weight bisphenol A type epoxy resin (number average molecular weight: approx. 1000), 50 g of terephthalic acid, 5 g of benzoic acid, and 300 g of xylene into a separable flask equipped with a stirrer, a thermometer, a nitrogen inlet, and a condenser. The mixture was heated to 70 to 100 degrees Celsius under a nitrogen atmosphere, after which 0.183 g of lithium chloride was added. The temperature was then increased to 160 degrees Celsius, and the xylene was removed under reduced pressure. The polymerization was continued at a reaction temperature of 180 degrees Celsius for 4 to 6 hours to obtain the [Polyol Resin]. The resulting [Polyol Resin] had a glass transition temperature of 61.4 degrees Celsius, an acid value of 11.5 mgKOH/g, a weight average molecular weight (Mw) of 9,500, a number average molecular weight (Mn) of 2,750, and an Mw/Mn ratio of 3.5.

### Method of Producing Base Toner Particle

### Production of Base Toner Particles 1 to 4

According to the prescription shown in Table 1, the toner's raw material mentioned above was preliminarily mixed by a HENSCHEL MIXER (FM20B, manufactured by NIPPON COKE & ENGINEERING CO., LTD.) and thereafter, melt-kneaded at 100 to 130 degrees Celsius by a single-shaft kneader (Ko-Kneader, available from BUSS). The thus-obtained kneaded material was cooled down to room temperature followed by coarse-pulverization to 200 to 300 μm by a Rotoplex. Next, the coarsely pulverized matter was finely-pulverized under an adjusted pulverization air pressure with a counter jet mill (100AFG, available from Hosokawa Micron Corporation) to achieve a weight average molecular weight of from 6.5±0.3 μm. The finely pulverized matter was classified with an air classifier (EJ-LABO, available from MATSUBO Corporation) with a louver aperture adjusted to achieve a weight average molecular weight of 7=0.2 μm and a ratio of weight average particle diameter to number average particle diameter of at most 1.25 to prepare [Base Toner Particle 1] to [Base Toner Particle 4].

The presence of the aromatic petroleum resin at the release agent domain interface and in [Base Toner Particle 1] to [Base Toner Particle 4] obtained above was subjected to the following test. The analysis results are shown in Table 1.

Presence of Aromatic Petroleum Resin at Release Agent Domain Interface and within Toner

A scanning electron microscope (SEM (cold), Hitachi SU8230, manufactured by Hitachi High Technologies Corporation) was used to observe the cross sections of base toner particles.

The toner particles were embedded in an epoxy resin, and the cross sections were cut out with a microtome and stained with ruthenium. The cross sections were then observed at 8,000× magnification.

FIG. 1 is the SEM observation result of the cross section of the base toner particle of Example 1. In the image of FIG. 1, the black regions represent the release agent, the gray regions represent the aromatic petroleum resin, and the white regions represent the binder resin.

It was confirmed that the aromatic petroleum resin was present at the release agent domain interface and that it was dispersed within the matrix of the polyester resin.

FIG. 2 is an image processed version of FIG. 1, illustrating more clearly that the aromatic petroleum resin is present at the release agent particle domain interface.

The results are shown in Table 1.

### Evaluation Criterion

A: The aromatic petroleum resin is present at the release agent particle domain interface, and domains of the aromatic petroleum resin are also present in a dispersed state within the matrix of the polyester resin.
B: The aromatic petroleum resin is present only at the release agent particle domain interface.
C: The aromatic petroleum resin is not present at the release agent particle domain interface.

TABLE 1

| Base | | | | | | |
|---|---|---|---|---|---|---|
| toner | | | | | Aromatic petroleum | |
| particle | Binder resin | | Release agent | | resin | |
| No. | Type | Part | Type | Part | Type | Part |
| 1 | Polyester | 80 | FT wax | 4 | Styrene- | 6 |
| | Resin 1 | | FNP-0090, | | based resin | |
| | | | manufactured | | FTR-2140, | |
| | | | by NIPPON | | manufactured | |
| | | | SEIRO CO., | | by Mitsui | |
| | | | LTD.: melting | | Chemicals, | |
| | | | point of 90 | | Inc.: Tg of 82 | |
| | | | degrees | | degrees | |
| | | | Celsius | | Celsius | |
| 2 | Polyester | 80 | Carnauba | 4 | Styrene- | 6 |
| | Resin 1 | | wax | | based resin | |
| | | | WA-03, | | FTR-2140, | |
| | | | manufactured | | manufactured | |
| | | | by TOA | | by Mitsui | |
| | | | KASEI CO., | | Chemicals, | |
| | | | LTD.: melting | | Inc.: Tg of 82 | |
| | | | point of 84 | | degrees | |
| | | | degrees | | Celsius | |
| | | | Celsius | | | |
| 3 | Polyester | 86 | FT wax | 4 | — | 0 |
| | Resin 1 | | FNP-0090, | | | |
| | | | manufactured | | | |
| | | | by NIPPON | | | |
| | | | SEIRO CO., | | | |
| | | | LTD.: melting | | | |
| | | | point of 90 | | | |
| | | | degrees | | | |
| | | | Celsius | | | |
| 4 | Polyol | 80 | FT wax | 4 | Styrene- | 6 |
| | resin | | FNP-0090, | | based resin | |
| | | | manufactured | | FTR-2140, | |
| | | | by NIPPON | | manufactured | |
| | | | SEIRO CO., | | by Mitsui | |
| | | | LTD.: melting | | Chemicals, | |
| | | | point of 90 | | Inc.: Tg of 82 | |
| | | | degrees | | degrees | |
| | | | Celsius | | Celsius | |

| | | | Presence of |
|---|---|---|---|
| | | | aromatic |
| | | | petroleum |
| Base | | | resin at release |
| toner | | | agent domain |
| particle | Pigment | | interface and |
| No. | Type | Part | within toner |
| 1 | Carbon | 10 | A |
| | black | | |
| 2 | Carbon | 10 | C |
| | black | | |
| 3 | Carbon | 10 | C |
| | black | | |
| 4 | Carbon | 10 | C |
| | black | | |

### Preparation of Inorganic External Additive

### Preparation of Inorganic External Additive 1

One hundred gram of hydrophilic silica particles (Aerosil 200, manufactured by Nippon Aerosil Co., Ltd.; average primary particle diameter: 12 nm) were dispersed in 2 L of water and heated to 85 degrees Celsius. Next, an aqueous aluminum chloride solution was added in an amount corresponding to 10 percent by mass as Al₂O₃ relative to the silica particles. After adjusting the pH to 5.5 with a sodium hydroxide aqueous solution, the mixture was stirred and maintained for 30 minutes. The resulting slurry was filtered, and the residue on the filter medium was washed with water to obtain a wet cake. The wet cake was then dried at 120 degrees Celsius and pulverized using a media-type fine pulverizer. Finally, 40 g of the resulting powder was placed into a small mixer, and 10.6 g of isobutyltrimethoxysilane was added. After mixing for 15 minutes, the mixture was dried again at 120 degrees Celsius to obtain [Inorganic External Additive 1].

The average particle diameter of [Inorganic External Additive 1] was 12 nm. The term ‘average particle diameter’ herein refers to a number-average particle diameter.

### Preparation of Inorganic External Additive 2

One hundred gram of hydrophilic silica particles (Aerosil 200, manufactured by Nippon Aerosil Co., Ltd.; average primary particle diameter: 12 nm) were dispersed in 2 L of water and heated to 85 degrees Celsius. Next, an aqueous zinc chloride solution was added in an amount corresponding to 10 percent by mass as ZnO relative to the silica particles. After adjusting the pH to 8.0 with a sodium hydroxide aqueous solution, the mixture was stirred and maintained for 30 minutes. The resulting slurry was filtered, and the residue on the filter medium was washed with water to obtain a wet cake. The wet cake was then dried at 120 degrees Celsius and pulverized using a media-type fine pulverizer. Finally, 40 g of the resulting powder was placed into a small mixer, and 10.6 g of isobutyltrimethoxysilane was added. After mixing for 15 minutes, the mixture was dried again at 120 degrees Celsius to obtain [Inorganic External Additive 2].

The average particle diameter of [Inorganic External Additive 2] was 12 nm.

### Preparation of Inorganic External Additive 3

One hundred gram of hydrophilic silica particles (Aerosil 200, manufactured by Nippon Aerosil Co., Ltd.; average primary particle diameter: 12 nm) were dispersed in 2 L of water and heated to 85 degrees Celsius. Next, an aqueous magnesium chloride solution was added in an amount corresponding to 10 percent by mass as MgO relative to the silica particles. After adjusting the pH to 5.0 with a sodium hydroxide aqueous solution, the mixture was stirred and maintained for 30 minutes. The resulting slurry was filtered, and the residue on the filter medium was washed with water to obtain a wet cake. The wet cake was then dried at 120 degrees Celsius and pulverized using a media-type fine pulverizer. Finally, 40 g of the resulting powder was placed into a small mixer, and 10.6 g of isobutyltrimethoxysilane was added. After mixing for 15 minutes, the mixture was dried again at 120 degrees Celsius to obtain [Inorganic External Additive 3].

The average particle diameter of [Inorganic External Additive 3] was 12 nm.

### Preparation of Inorganic External Additive 4

One hundred gram of hydrophilic silica particles (Aerosil 200, manufactured by Nippon Aerosil Co., Ltd.; average primary particle diameter: 12 nm) were dispersed in 2 L of water and heated to 85 degrees Celsius. Next, an aqueous iron chloride solution was added in an amount corresponding to 10 percent by mass as FeO relative to the silica particles. After adjusting the pH to 8.5 with a sodium hydroxide aqueous solution, the mixture was stirred and maintained for 30 minutes. The resulting slurry was filtered, and the residue on the filter medium was washed with water to obtain a wet cake. The wet cake was then dried at 120 degrees Celsius and pulverized using a media-type fine pulverizer. Finally, 40 g of the resulting powder was placed into a small mixer, and 10.6 g of isobutyltrimethoxysilane was added. After mixing for 15 minutes, the mixture was dried again at 120 degrees Celsius to obtain [Inorganic External Additive 4].

The average particle diameter of [Inorganic External Additive 4] was 12 nm.

### Preparation of Inorganic External Additive 5

One hundred gram of hydrophilic silica particles (Aerosil 90, manufactured by Nippon Aerosil Co., Ltd.; average primary particle diameter: 25 nm) were dispersed in 2 L of water and heated to 85 degrees Celsius. Next, an aqueous aluminum chloride solution was added in an amount corresponding to 10 percent by mass as Al₂O₃ relative to the silica particles. After adjusting the pH to 5.5 with a sodium hydroxide aqueous solution, the mixture was stirred and maintained for 30 minutes. The resulting slurry was filtered, and the residue on the filter medium was washed with water to obtain a wet cake. The wet cake was then dried at 120 degrees Celsius and pulverized using a media-type fine pulverizer. Finally, 40 g of the resulting powder was placed into a small mixer, and 10.6 g of isobutyltrimethoxysilane was added. After mixing for 15 minutes, the mixture was dried again at 120 degrees Celsius to obtain [Inorganic External Additive 5].

The average particle diameter of [Inorganic External Additive 5] was 25 nm.

### Preparation of Inorganic External Additive 6

One hundred gram of hydrophilic silica particles (Aerosil 300, manufactured by Nippon Aerosil Co., Ltd.; average primary particle diameter: 8 nm) were dispersed in 2 L of water and heated to 85 degrees Celsius. Next, an aqueous aluminum chloride solution was added in an amount corresponding to 10 percent by mass as Al₂O₃ relative to the silica particles. After adjusting the pH to 5.5 with a sodium hydroxide aqueous solution, the mixture was stirred and maintained for 30 minutes. The resulting slurry was filtered, and the residue on the filter medium was washed with water to obtain a wet cake. The wet cake was then dried at 120 degrees Celsius and pulverized using a media-type fine pulverizer. Finally, 40 g of the resulting powder was placed into a small mixer, and 10.6 g of isobutyltrimethoxysilane was added. After mixing for 15 minutes, the mixture was dried again at 120 degrees Celsius to obtain [Inorganic External Additive 6].

The average particle diameter of [Inorganic External Additive 6] was 8 nm.

### Preparation of Inorganic External Additive 7

One hundred gram of hydrophilic silica particles (Aerosil 50, manufactured by Nippon Aerosil Co., Ltd.; average primary particle diameter: 35 nm) were dispersed in 2 L of water and heated to 85 degrees Celsius. Next, an aqueous aluminum chloride solution was added in an amount corresponding to 10 percent by mass as Al₂O₃ relative to the silica particles. After adjusting the pH to 5.5 with a sodium hydroxide aqueous solution, the mixture was stirred and maintained for 30 minutes. The resulting slurry was filtered, and the residue on the filter medium was washed with water to obtain a wet cake. The wet cake was then dried at 120 degrees Celsius and pulverized using a media-type fine pulverizer. Finally, 40 g of the resulting powder was placed into a small mixer, and 10.6 g of isobutyltrimethoxysilane was added. After mixing for 15 minutes, the mixture was dried again at 120 degrees Celsius to obtain [Inorganic External Additive 7].

The average particle diameter of [Inorganic External Additive 7] was 35 nm.

### Preparation of Inorganic External Additive 8

One hundred gram of hydrophilic silica particles (Aerosil 200, manufactured by Nippon Aerosil Co., Ltd.; average primary particle diameter: 12 nm) were dispersed in 2 L of water and heated to 85 degrees Celsius. Next, an aqueous aluminum chloride solution was added in an amount corresponding to 10 percent by mass as Al₂O₃ relative to the silica particles. After adjusting the pH to 5.5 with a sodium hydroxide aqueous solution, the mixture was stirred and maintained for 30 minutes. The resulting slurry was filtered, and the residue on the filter medium was washed with water to obtain a wet cake. Next, the resulting wet cake was dried at 120 degrees Celsius and then pulverized with a media type fine pulverizer to obtain [Inorganic External Additive 8].

The average particle diameter of [Inorganic External Additive 8] was 12 nm.

The details of the obtained inorganic external additives are shown in Table 2.

TABLE 2

| | | | Presence | |
|---|---|---|---|---|
| | | | of coating | |
| | Presence of | | of | Volume |
| Inorganic | coating at | | uppermost | average |
| external | hydroxide of | Type of | surface | particle |
| additive | metal | metal | with | diameter |
| No. | element | element | alkylsilane | (nm) |
| Inorganic | Yes | Aluminum | Yes | 12 |
| external | | | | |
| additive 1 | | | | |
| Inorganic | Yes | Zinc | Yes | 12 |
| external | | | | |
| additive 2 | | | | |
| Inorganic | Yes | Magnesium | Yes | 12 |
| external | | | | |
| additive 3 | | | | |
| Inorganic | Yes | Iron | Yes | 12 |
| external | | | | |
| additive 4 | | | | |
| Inorganic | Yes | Aluminum | Yes | 25 |
| external | | | | |
| additive 5 | | | | |
| Inorganic | Yes | Aluminum | Yes | 8 |
| external | | | | |
| additive 6 | | | | |
| Inorganic | Yes | Aluminum | Yes | 35 |
| external | | | | |
| additive 7 | | | | |
| Inorganic | Yes | Aluminum | None | 12 |
| external | | | | |
| additive 8 | | | | |

### Method of Producing Toner

### Production of Toners 1 to 12

Using the combinations of base toner particles and inorganic external additives shown in Table 3, 1.0 part of silica (HDK-2000, manufactured by Clariant Japan K.K.) and 0.5 parts by mass of the inorganic external additive were mixed with 100 parts of the base toner particles in a Henschel mixer to produce [Toner 1] to [Toner 12].

### Preparation of Two Component Developing Agent

Preparation of Carrier

| | |
|---|---|
| Silicone resin (Organo straight silicone): | 100 parts |
| Toluene: | 100 parts |
| γ-(2-aminoethyl)aminopropyl trimethoxy silane: | 5 parts |
| Carbon black: | 10 parts |

The mixture specified above was dispersed by a Homomixer for 20 minutes to prepare a liquid for forming a coating layer. This liquid was applied to Mn ferrite particles, which had a weight average particle size of 35 μm, as core material, using a fluidized bed coating device. The temperature inside the fluidizing chamber was controlled at 70 degrees Celsius to form a coating layer with an average thickness of 0.20 μm on the surface of the core materials. The coated particles were then dried to obtain a carrier.

The thus-obtained carrier was baked in an electric furnace at 180 degrees Celsius for two hours to obtain Carrier.

### Manufacturing of Two Component Developing Agents 1 to 12

The prepared [Toner 1] to [Toner 12] were uniformly mixed with the Carrier using a Turbula mixer (manufactured by Willy A. Bachofen AG (WAB)) at 48 rpm for 5 minutes to charge the toner, thereby producing two-component developing agents 1 to 12. The toner-to-carrier mixing ratio was adjusted to match the initial toner concentration of the developing agent-4 percent by mass-in the evaluation machine.

### Evaluation on Properties of Toner

### Volume Average Particle Diameter of Toner

The volume average particle diameter of the toner was measured using a Coulter Counter Multisizer III. A measurement sample was prepared by adding the toner to an electrolytic solution containing a surfactant and dispersing it for 1 minute with an ultrasonic disperser. A total of 50,000 particles were measured, and the volume average particle diameter of the toner was calculated. The results are shown in Table 3.

### Average Circularity

Using a flow-type particle image analyzer (Flow Particle Image Analyzer) FPIA-3000 (manufactured by Sysmex Corporation), 0.1 to 0.5 mL of an alkylbenzene sulfonate was added as a dispersant to 100 to 150 mL of water in a container from which foreign solid matter had been previously removed. Then approximately 0.1 to 0.5 g of the measurement sample was added, and the resulting suspension was dispersed for about 1 to 3 minutes using an ultrasonic disperser. The dispersion was adjusted to a concentration of 3,000 to 10,000 particles/μL and the toner shape was measured using the above device. The results are shown in Table 3.

### Low Temperature Fixability

The toner developing agent obtained was placed in a machine (process speed of 256 mm/sec) remodeled based on a Ricoh photocopier (RICOH IM 6000) available from Ricoh Co., Ltd., followed by image outputting. A solid image with an attached amount of 0.4 mg/cm² was output on paper (Type 6200, available from Ricoh Company, Ltd.) through the irradiation, development, and transfer processes. The fixing temperature was sequentially output in 5-degree Celsius increments, and the lowest temperature at which no cold offset occurred (lower limit fixing temperature (minimum fixing temperature) low temperature fixability) was measured. Based on the evaluation criterion below, the low temperature fixability was assessed, and the results are shown in Table 3. It is determined that a rating of B or higher is sufficient for practical use.

### Evaluation Criterion

S: Lower than 120 degrees Celsius
A: 120 to lower than 125 degrees Celsius
B: 125 to lower than 130 degrees Celsius
C: no lower than 130 degrees Celsius

### Hot Offset Resistance

Each developing agent was placed in the accommodating unit of a machine (process speed of 256 mm/sec) remodeled based on a photocopier (RICOH IM 6000, manufactured by Ricoh Co., Ltd.). The photocopier continuously formed a solid image with an attached amount of 0.4 mg/cm² of the developing agent on a printing media (Type 6200, manufactured by Ricoh Co., Ltd.). The fixing temperature was sequentially output in 5 degree Celsius increments, and the upper temperature at which no hot offset occurred (maximum fixing temperature: hot offset resistance) was measured. The hot offset resistance was evaluated based on the evaluation criterion described below, and the results are shown in Table 3. It is determined that a rating of B or higher is sufficient for practical use.

### Evaluation Criterion

S: Maximum fixing temperature is at least 200 degrees Celsius
A: Maximum fixing temperature is from 190 to lower than 200 degrees Celsius
B: Maximum fixing temperature is from 180 to lower than 190 degrees Celsius
C: Maximum fixing temperature is lower than 180 degrees Celsius

### High Temperature Storage Stability (Heat Storage Stability)

Storage property was measured using a penetrometer (manufactured by Nikka Engineering Co., Inc.).

Specifically, 10 g of each toner was weighed and placed in a glass container (30 ml screw vial) in an environment of 20 to 25 degrees Celsius and 40 to 60 percent relative humidity (RH). The lid of the container was then closed. After the glass container containing the toner was tapped 100 times, the glass container was left in a thermostatic chamber set at 50 degrees Celsius for 24 hours. Thereafter, the degree of penetration of the toner was measured with a penetrometer. The high temperature storage stability thereof was evaluated according to the following evaluation criterion.

A larger penetration value indicates better high temperature storage stability.

The results are shown in Table 3, and it is determined that a rating of B or higher is sufficient for practical use.

### Evaluation Criterion

A: degree of penetration was at least 30 mm
B: degree of penetration was 25 mm to less than 30 mm
C: degree of penetration was 20 mm to less than 25 mm
D: degree of penetration was less than 20 mm

### Anti-Filming

Each developing agent was loaded into a machine remodeled based on a RICOH IM 6000 copier (manufactured by Ricoh Company, Ltd.; process speed: 256 mm/sec), and a continuous running test was conducted at a print coverage of 1 percent, using TANOSÉE PPC Paper Type FW (A4, manufactured by OTSUKA CORPORATION). Whether or not filming occurred to a photoreceptor or defective images (half tone image uneven density) attributable to filming were printed was checked after printing 20,000 sheet, 50,000 sheet, and 100,000 sheets. Filming tends to occur as the number of printed sheets increases.

The results are shown in Table 3, and it is determined that a rating of B or higher is sufficient for practical use.

### Evaluation Criterion

A: No filming after 100,000 sheets
B: Filming observed at 50,000th sheet
B: Filming observed at 10,000th sheet

### Evaluation on Long-Term Charging Stability

Each developing agent was loaded into a machine remodeled based on a RICOH IM 6000 copier (manufactured by Ricoh Company, Ltd.; process speed: 256 mm/sec), and 200,000 copies of a test chart having an image area of 6 percent were produced. The developing agent was evaluated based on the degree of decrease in their charge amount.

The results are shown in Table 3, and it is determined that a rating of B or higher is sufficient for practical use.

Evaluation Criterion for Long-term Charge Stability
A: The decrease in charge amount is very small, and the durability is excellent
B: The decrease in charge amount is small, and the durability is superior to that of typical toners
C: The durability is equal to or lower than that of typical toners

### Evaluation Criteria on Abnormal Images

Each developing agent was loaded into a machine remodeled based on a RICOH IM 6000 copier (manufactured by Ricoh Company, Ltd.; process speed: 256 mm/sec), and under high temperature and high humidity conditions (27 degrees Celsius, 80 percent RH), 200,000 copies of a test chart having an image area of 6 percent were produced using “Askul Super White+” paper. The presence or absence of defective black streaks on images was evaluated.

The results are shown in Table 3, and it is determined that a rating of B or higher is sufficient for practical use.

### Evaluation Criteria on Abnormal Images

A: The occurrence rate of abnormal images is less than 10 percent
B: The occurrence rate of abnormal images is 10 to less than 20 percent
C: The occurrence rate of abnormal images is at least 20 percent

TABLE 3

| | | | | Volume | |
|---|---|---|---|---|---|
| | | Base | Inorganic | average | |
| Example/ | | toner | external | particle | |
| Comparative | Toner | particle | additive | diameter | Average |
| Example No. | No. | No. | No. | (nm) | circularity |
| Example 1 | Toner 1 | 1 | 1 | 6.9 | 0.93 |
| Example 2 | Toner 2 | 1 | 2 | 6.9 | 0.93 |
| Example 3 | Toner 3 | 1 | 3 | 6.9 | 0.93 |
| Example 4 | Toner 4 | 1 | 4 | 6.9 | 0.93 |
| Example 5 | Toner 5 | 1 | 5 | 6.9 | 0.93 |
| Example 6 | Toner 6 | 1 | 6 | 6.9 | 0.93 |
| Example 7 | Toner 7 | 1 | 7 | 6.9 | 0.93 |
| Example 8 | Toner 8 | 1 | 8 | 6.9 | 0.93 |
| Comparative | Toner 9 | 1 | None | 6.9 | 0.93 |
| Example 1 | | | | | |
| Comparative | Toner 10 | 2 | 1 | 7.1 | 0.93 |
| Example 2 | | | | | |
| Comparative | Toner 11 | 3 | 1 | 7.5 | 0.91 |
| Example 3 | | | | | |
| Comparative | Toner 12 | 4 | 1 | 6.8 | 0.92 |
| Example 4 | | | | | |

| | | | | | | Charge | |
|---|---|---|---|---|---|---|---|
| Example/ | | Low | | Heat | | stability | |
| Comparative | Toner | temperature | Hot offset | storage | Anti- | over | Abnormal |
| Example No. | No. | fixability | resistance | stability | filming | time | image |
| Example 1 | Toner 1 | A | A | A | A | A | A |
| Example 2 | Toner 2 | A | A | A | A | A | A |
| Example 3 | Toner 3 | A | A | A | A | A | A |
| Example 4 | Toner 4 | A | A | A | A | B | A |
| Example 5 | Toner 5 | B | A | S | A | A | A |
| Example 6 | Toner 6 | S | A | B | B | A | B |
| Example 7 | Toner 7 | B | S | S | S | A | A |
| Example 8 | Toner 8 | A | A | A | A | B | B |
| Comparative | Toner 9 | A | A | B | C | C | C |
| Example 1 | | | | | | | |
| Comparative | Toner 10 | A | A | B | C | C | C |
| Example 2 | | | | | | | |
| Comparative | Toner 11 | C | B | C | C | C | C |
| Example 3 | | | | | | | |
| Comparative | Toner 12 | C | C | C | C | C | C |
| Example 4 | | | | | | | |

The aspects of the present disclosure are, for example, as follows:

### Aspect 1

A toner contains a toner particle that contains a base toner particle containing a polyester resin, a release agent, and an aromatic petroleum resin, and an external additive including silica particles whose surfaces are at least partially coated with a hydroxide of a metal element, wherein, in a cross section of the toner particle observed with a scanning electron microscope, the aromatic petroleum resin is present at an interface of a domain of the release agent, and domains of the aromatic petroleum resin are dispersed within a matrix of the polyester resin.

### Aspect 2

The toner according to Aspect 1 mentioned above, wherein the release agent contains a hydrocarbon wax.

### Aspect 3

The toner according to Aspect 1 or 2 mentioned above, wherein the toner contains 5 to 10 parts by mass of the aromatic petroleum resin per 100 parts by mass of the toner.

### Aspect 4

The toner according to any one of Aspects 1 to 3 mentioned above, wherein the silica particles have uppermost surfaces coated with an alkylsilane.

### Aspect 5

The toner according to any one of Aspects 1 to 4 mentioned above, wherein the metal element is at least one member selected from the group consisting of aluminum, zinc, and magnesium.

### Aspect 6

The toner according to any one of Aspects 1 to 5 mentioned above, wherein the silica particles have a number average particle diameter of 10 to 30 nm.

### Aspect 7

A developing agent contains the toner of any one of Aspects 1 to 6 mentioned above and a carrier.

### Aspect 8

A toner accommodating unit contains the toner of any one of Aspects 1 to 7 mentioned above and a container accommodating the toner.

### Aspect 9

An image forming apparatus contains an electrostatic latent image bearer, an electrostatic latent image forming device to form an electrostatic latent image on the electrostatic latent image bearer and a developing device to develop the electrostatic latent image formed on the electrostatic latent image bearer with the toner of any one of Aspects 1 to 8 mentioned above to form a toner image and a transfer device to transfer the toner image onto a transfer body.

10. An image forming method includes charging an electrostatic latent image bearer, forming an electrostatic latent image on the electrostatic latent image bearer that is charged, developing the electrostatic latent image with the toner of any one of Aspects 1 to 8 mentioned above to form a toner image, transferring the toner image to a transfer body, cleaning the surface of the electrostatic latent image bearer with a cleaning device after the toner image is transferred, and fixing the toner image.

### Aspect 11

The image forming method according to Aspect 10 mentioned above, further includes recycling the toner retrieved in the cleaning of the surface of the electrostatic latent image bearer, and using the retrieved toner as toner for development.

The above-described embodiments are illustrative and do not limit the present invention. Thus, numerals additional modifications and variations are possible in light of the above-teachings. For example, elements and/or features of difference illustrative embodiments may be combined with each other and/or substituted for each other within the scope of the present invention. Any one of the above-described operations may be performed in various other ways, for example, in an order difference from the one described above.

1. A toner comprising:
a toner particle comprising:
a base toner particle comprising:
a polyester resin;
a release agent; and
an aromatic petroleum resin; and
an external additive including silica particles whose surfaces are at least partially coated with a hydroxide of a metal element,
wherein, in a cross section of the toner particle observed with a scanning electron microscope, the aromatic petroleum resin is present at an interface of a domain of the release agent, and domains of the aromatic petroleum resin are dispersed within a matrix of the polyester resin.

2. The toner according to claim 1,
wherein the release agent comprises a hydrocarbon wax.

3. The toner according to claim 1, wherein the toner contains 5 to 10 parts by mass of the aromatic petroleum resin per 100 parts by mass of the toner.

4. The toner according to claim 1,
wherein the silica particles have uppermost surfaces coated with an alkylsilane.

5. The toner according to claim 1,
wherein the metal element is at least one member selected from the group consisting of aluminum, zinc, and magnesium.

6. The toner according to claim 1,
wherein the silica particles have a number average particle diameter of 10 to 30 nm.

7. A developing agent comprising:
the toner of claim 1; and
a carrier.

8. A toner accommodating unit comprising:
the toner of claim 1; and
a container accommodating the toner.

9. An image forming apparatus comprising:
an electrostatic latent image bearer;
an electrostatic latent image forming device to form an electrostatic latent image on the electrostatic latent image bearer; and
a developing device to develop the electrostatic latent image formed on the electrostatic latent image bearer with the toner of claim 1 to form a toner image; and
a transfer device to transfer the toner image onto a transfer body.

10. An image forming method comprising:
charging an electrostatic latent image bearer;
forming an electrostatic latent image on the electrostatic latent image bearer that is charged;
developing the electrostatic latent image with the toner of claim 1 to form a toner image;
transferring the toner image to a transfer body;
cleaning a surface of the electrostatic latent image bearer with a cleaning device after the toner image is transferred; and
fixing the toner image.

11. The image forming method according to claim 10,
further comprising recycling the toner retrieved in the cleaning of the surface of the electrostatic latent image bearer, and using the toner retrieved as toner for development.
